(19) United States
(12) Patent Application Publication
(10) Pub. No.: US 2008/0284706 A1
(43) Pub. Date: Nov. 20, 2008

(54) Driving Liquid Crystal Display with a Polarity Inversion Pattern

(75) Inventors: Age Jochem Van Dalfsen, Eindhoven (NL); Aleksandar Sevo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,927

(22) PCT Filed: Jun. 17, 2005
(86) PCT No.: PCT/IB2005/051995

§ 371 Date: Dec. 19, 2006

(30) Foreign Application Priority Data
Jun. 22, 2004 (EP) 04102882.0

(51) Int. Cl. G09G 3/36; G02F 1/133

(52) U.S. Cl. 345/96; 349/37

(57) ABSTRACT

This invention relates to driving a liquid crystal display with a polarity inversion. The liquid crystal display panel (98) comprises a matrix of pixels (52, 62, 72), which is driven with a sequence of image frames. The method comprises driving the pixels during a first frame (n−1) with a first polarity pattern; driving the pixels with exception of a first set of pixels (54, 66, 74) during a second frame (n) with an inverted polarity pattern; and driving the first set of pixels (54, 66, 74) with the inverted polarity pattern during a third frame (n+1).

### FIELD OF INVENTION

This invention relates to driving a matrix of pixels with a polarity inversion scheme. In particular, this invention relates to preventing image sticking or image retention on an active matrix liquid crystal display device.

### BACKGROUND OF INVENTION

An active matrix device, such as described in U.S. Pat. No. 6,469,684, which hereby is incorporated in the present specification by reference, comprises an inversion circuitry coupled to drive signals, which inversion circuitry has at least one Cole sequence generator providing random, semi-random, or pseudo-random sequence patterns of the matrix. The Cole sequence generator provides a sequence of inversion patterns of pixel biasing over several frames. Over time each pixel is presented with a substantially equal number of positive and negative drive levels to prevent the generation of undesirable display artifacts that might occur under a direct current bias. The prior-art patent further discloses that when using the Cole sequence generator, it is required to compensate for spatial related errors such as long strings of pixels biased positively or negatively thereby generating display artifacts, or spatial related errors such as flicker caused if groups of pixels change near each other in time. These errors are compensated by having a rapidly changing inversion pattern, which does not repeat often.

Generally for television applications, however, pixel biasing is reversed once per frame, that is, with a frequency equal to a display refresh rate and synchronous with a video signal. A non-zero DC-component causes electroplating of ion impurities in the liquid crystal in the electrodes, which is a major source for image retention or image sticking. This problem is particularly encountered in no de-interlace or poor de-interlace television applications of active matrix liquid crystal displays.

### SUMMARY OF THE INVENTION

An object of the present invention is to provide driving a matrix of pixels with a polarity inversion pattern, which further reduces image sticking. The invention is defined by the independent claims. The dependent claims define advantageous embodiments.

When reversing once per frame a regular polarity pattern for an interlaced television signal, then the first polarity pattern is, for example, applied to odd frames of the television signal, while the inverted polarity pattern is linked with the even frames of the television signal. As the content of odd and even frames may be different, pixels may be driven for a number of frames with, for example, a large voltage driving odd frames in combination with a positive polarity, and a small voltage during even frames in combination with a negative polarity. As a result, the pixel is driven with a non-zero DC component causing image retention after some time.

By excluding the first set of pixels from being driven with the inverted polarity pattern, during the second frame, which means that this set of pixels is driven with the first polarity pattern during this second frame, the regular scheme of inverting the pattern for subsequent frames is interrupted for this first set of pixels. By continuing again inverting the polarity pattern during the third frame, effectively the regular scheme of inverting the pattern for subsequent frames is resumed again, however, now with an opposite polarity with respect to the odd and even frames. As a result, any non-zero DC-component built-up before the second frame due to stationary differences between the content of odd and even frames, is compensated from the second frame onwards because the polarity of the odd and even frames is reversed. Hence, even for television signals with poor or no de-interlacing image sticking is reduced.

By driving the pixels with subsequent exception of mutually different sets of pixels in subsequent frames with the inverted pattern, the polarity scheme for odd and even frames is subsequently reversed for all pixels of the matrix of pixels. This provides a fully controlled polarization inversion scheme limiting charge build up on pixels in the temporal domain.

For case of implementation, the first set of pixels may comprise neighboring pixels in one or more rows or columns of the matrix of pixels, the subsequently excepted sets of pixels may be subsequent, neighboring sets of pixels, and/or the first set of pixels may be one or more entire rows or columns.

If the first set of pixels and the mutually different sets of pixels each comprise less then half of the total amount of pixels in the matrix, a flicker effect caused by the change of the polarity scheme is reduced.

The matrix of pixels may be a matrix of Liquid Crystal Display pixels, or any other matrix display showing the phenomenon of building up a non-zero DC-component.

The driving circuitry may be formed by an integrated circuit, or by a group of integrated circuits which may have peripheral components.

The display product may be a television receiver, a monitor, a projector, or any other product with a display device.

The video processing circuitry converts an external input signal, for example, from an antenna or from an external input device such as a DVD-player or computer coupled to the product, into a format suitable for driving the display device.

A particular feature of the present invention relates to a video signal manipulating circuit for compensating for biasing difference. This feature reduces the visibility of the change of the polarity pattern caused by the relatively slow response of especially Liquid Crystal Display pixels to drive signals.

Usually, this response is partially compensated by so called “overdrive” as, for example, disclosed in U.S. Pat. No. 5,495,265. To compensate, however, for the change of the polarity pattern an opposite correction is required, which may be called “under-drive”. This required correction may be obtained by measuring the behavior of the matrix of pixels for the available transitions of grey levels of the pixels, storing the required corrections of the transitions, and applying these corrections in case a change of polarity scheme takes place. This approach is similar to the approach described in U.S. Pat. No. 5,495,265 and is therefore not further detailed in this application.

In an embodiment the available overdrive circuitry or software is used to provide the underdrive: in case a change of polarity scheme for a pixel, the required correction is retrieved, for example, from look-up table and/or via a formula, and the correction is combined with the overdrive correction, so as to provide the correct drive signal to the pixel.

These and other aspects of the present invention are apparent from and will be elucidated with reference to the embodiments described hereinafter.

### BRIEF DESCRIPTION OF THE DRAWINGS

The invention is described further by way of example only with reference to the appended drawings, wherein:

FIG. 1 shows a graph of a prior art driving voltage for a pixel versus time;

FIG. 2 shows a prior art polarity inversion scheme over time;

FIG. 3 shows a graph of a prior art driving voltage for a pixel versus time, which driving voltage comprises a DC offset component, for example, due to no or a bad de-interlacer;

FIG. 4 shows a graph of a driving voltage for a pixel versus time according to a first embodiment of the present invention;

FIG. 5 shows a polarity inversion scheme according to the first embodiment of the present invention over time;

FIG. 6 shows a polarity inversion scheme according to a second embodiment of the present invention over time;

FIG. 7 shows a polarity inversion scheme according to a third embodiment of the present invention over time;

FIG. 8 shows a graph of the driving voltage across a pixel over time according to the first through third embodiment of the present invention; and

FIG. 9 shows a block diagram of a compensation circuitry according to the first through third embodiment of the present invention.

### DETAILED DESCRIPTION OF PREFERRED EMBODIMENTS

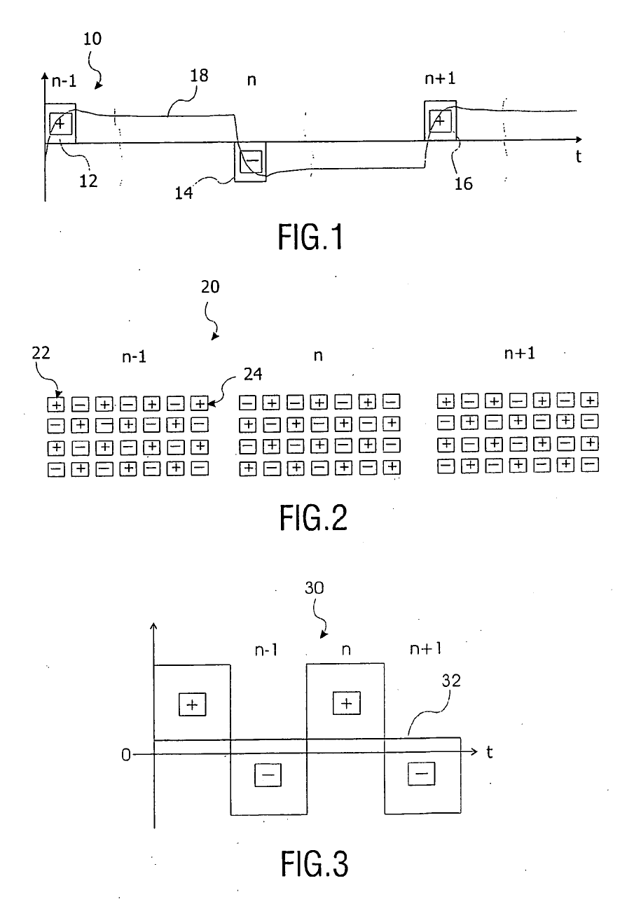

FIG. 1 shows a graph of a prior art driving voltage 10 as function of time t during three frames n−1, n, and n+1 and defining a series of alternating pulses 12, 14, 16 causing a charging and discharging pixel voltage 18. The response of the pixel voltage 18, during excitation by pulses 12, 14, and 16 is dependent on driver output resistance, the resistance of the indium tin oxide (ITO) layer, and the drain-source resistance of the field effect transistor (FET) together with the storage capacitance, capacitance of the liquid crystal cell and the distributed capacitance of the ITO layer. The total resistance in combination with the total capacitance results in a slow response of the pixel voltage 18 to a drive signal formed by the alternating pulse 12, 14, 16.

FIG. 2 shows a prior art polarity inversion scheme for a matrix of pixels 20. The scheme shows the polarity pattern for a number of frames n−1, n, n+1. The polarity for each pixel in subsequent frames n−1, n, n+1 is indicated with “+” and “−” The polarity of the pixels in the matrix 20 alternates between neighboring pixels in a column 22 (and all other columns) as well as in a row 24 (and any other row). In addition, each pixel of the matrix 20 alternates in polarity between frames.

The term “scheme” is in this context to be construed as a method or procedure implemented to be performed in a system utilizing hard- and/or software.

FIG. 3 shows a graph of a prior art driving voltage 30 for a pixel inverting polarity between each frame, wherein the pixel receives a changing video signal causing a DC offset 32. Depending on the level and shape of the driving voltage 30 it requires a couple of frames for the DC offset 32 to cause visible image retention.

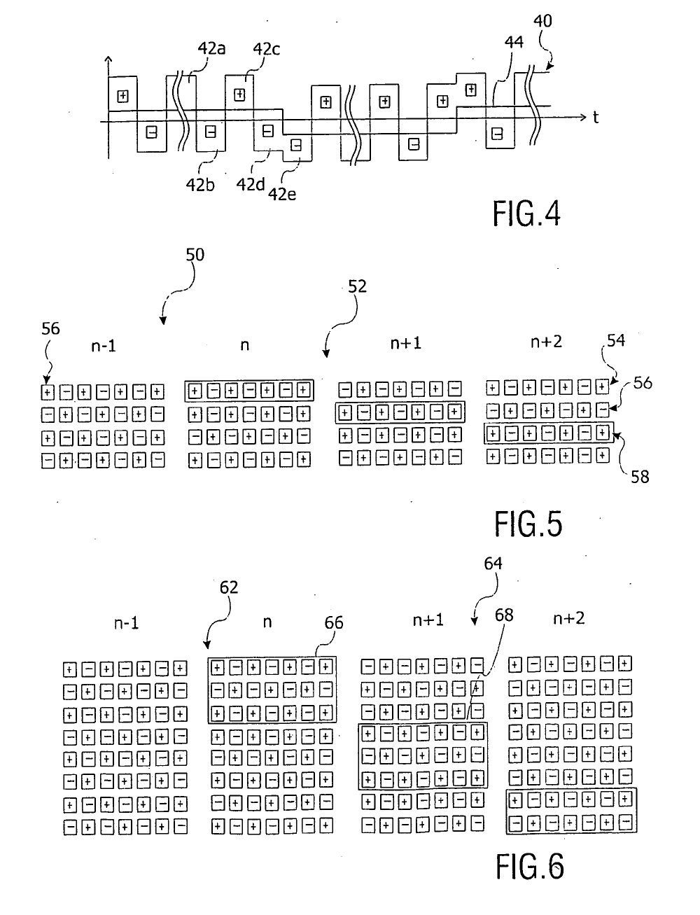

FIG. 4 shows a graph of a driving voltage 40 for a pixel as function of time t according to a first embodiment of the present invention, which driving voltage 40 has an alternating polarity during a predefined number of frames, exemplified by reference numerals 42a through 42d. Thereafter, the driving voltage 40 has an inverted polarity inversion scheme and repeats the polarity of frame 42d in frame 42e. This introduces a shift or a polarity alternation of a DC offset 44, thereby compensating for charge building up across a pixel for an extended period of time, since the DC offset 44 averages zero over time. Consequently, the driving voltage 40 according to the present invention prevents image retention on a liquid crystal display.

FIG. 5 shows a polarity inversion scheme 50 according to the first embodiment of the present invention for a matrix of pixels 52. The polarity for each pixel in subsequent frames n−1, n, n+1 and n+2 is indicated with “+” and “−”. The polarity of the pixels in the matrix 52 alternates between neighboring pixels in a row 54 as well as in a column 56 during a frame n−1. The polarity inversion scheme 50 inverts polarity of pixels between frames except for the row 54 of the matrix 52, during the frame n. In the frame n+1 the polarity inversion scheme 50 inverts the polarity of pixels, except for the pixels of row 56, and in the frame n+2 the polarity inversion scheme 50 inverts the polarity of the pixels, except for the pixels of row 58. The polarity inversion scheme 50 thus excepts rows in the matrix 52 in a scrolling fashion, which may be continuous. The frequency of the alternation of the DC offset, shown in FIG. 4 as reference numeral 44, in the polarity inversion scheme 50 is determined by the number of rows in the matrix 52 and in the first embodiment the frequency is equal to the number of rows excepted times frame frequency divided by the total number of rows in the matrix.

FIG. 6 shows a polarity inversion scheme 62 according to the second embodiment of the present invention wherein the polarity inversion scheme excluding rows subsequently in subsequent frames is performed on a plurality of rows 66, 68 of a matrix of pixels 64 for frames n−1, n, n+1, n+2. The number of rows maintaining the same polarity in two consecutive frames should be less than a half of a total number of rows of the matrix, otherwise the frequency of polarity inversion on a pixel in the matrix 64 is smaller than the half of the frame frequency, and this may lead to visible large area flicker.

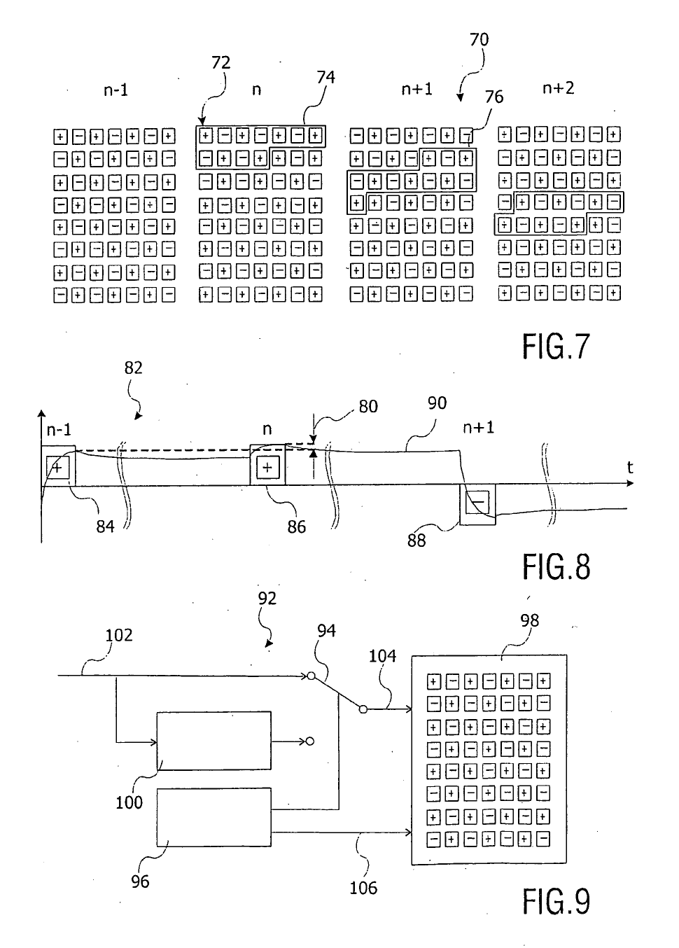

FIG. 7 shows a polarity inversion scheme 70 according to the third embodiment of the present invention, wherein the polarity inversion scheme excluding a row or a plurality of rows is not restricted to a number of rows, but may also be applied rather to a number of consecutive pixels 74, 76. The polarity inversion exception is in an alternative embodiment not even restricted to consecutive pixels. In fact, it is only important to make a driving voltage, shown in FIG. 4 as reference numeral 40, for each pixel in a matrix 72. However, having the polarity inversion exception restricted to consecutive pixels provides a cheaper hardware solution.

During a change of the polarity inversion scheme, so when excluding a row, a plurality of rows, or pixels as described with reference to above figures, the light output of a liquid crystal display slightly increases for a normally black display and decreases for a normally white display. This difference 80 in light output, which is shown in FIG. 8, is visible and should be compensated. The difference 80 is caused by the slow response of the pixel to the drive signal as explained with reference to FIG. 1.

FIG. 8 shows a graph of driving voltage 82 according to the first through third embodiment of the present invention, during three frames n−1, n, and n+1, and a series of driving pulses 84, 86, 88. The driving pulses 84, 86, 88, cause a charging and discharging pixel voltage 90. Repeated pulse of a same polarity, such as pulses 84, 86 cause the difference 80 in the pixel voltage 90.

The difference 80 is, according to the first embodiment, compensated in the digital domain by manipulating video data to the display via compensation circuitry. Alternatively, the difference 80 may be compensated in the analogue domain, for example, in the column drivers, but this solution requires additional complex circuitry.

FIG. 9 shows a block diagram of a compensating unit 92 of a liquid crystal display driving system according to the first through third embodiment of the present invention. The compensating unit 92 comprises a switching unit 94 controlled by a pixel voltage polarity controller 96. The pixel voltage polarity controller 96 controls the switching unit 94, thereby controlling the pixel driving voltage for each pixel in a matrix of pixels in a liquid crystal display panel 98. Further, it controls the polarity of the pixels through the signal 106. When a change of the polarity inversion scheme takes place, the controller 96 controls the switching unit 94 to couple a video data manipulator 100 between a video input 102 for receiving a video content and video data output 104 of the compensating unit 92 for the concerned pixels in the matrix which are excepted in a polarity inversion. The video data manipulator 100 compensates for the voltage difference caused by the change of the polarity inversion scheme in combination with the slow response of the pixel voltage. As mentioned before, this compensation in the form of “underdrive” may be realized in a similar way as overdrive as disclosed in U.S. Pat. No. 5,495,265, so needs no further elaboration here.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1-13. (canceled)

14. A method (50, 62, 70) for driving a matrix of pixels with a sequence of image frames, the method comprising driving the pixels during a first frame (n−1) with a first polarity pattern; driving the pixels with exception of a first set of pixels (54, 66, 74) during a second frame (n) with an inverted polarity pattern; driving the first set of pixels (54, 66, 74) with the inverted polarity pattern during a third frame (n+1); and compensating for a biasing difference (80) of said first set of pixels during said second frame (n) caused by a response time of the first set of pixels.

15. A method (50, 62, 70) according to claim 14, wherein said first set of pixels (54, 66, 74) comprises neighboring pixels in one or more rows (54) of pixels or in one or more columns (56) of pixels in said matrix of pixels.

16. A method (50, 62, 70) according to claim 14, further comprising driving the pixels with subsequent exception of mutually different sets of pixels (68, 76) in subsequent frames (n+1) with the inverted polarity pattern compared to a previous frame.

17. A method (50, 62, 70) according to claim 16, wherein said mutually different sets of pixels (68, 76), which are subsequently excepted, are subsequent, neighboring sets of pixels.

18. A method (50, 62, 70) according to claim 16, wherein the first and the mutually different sets of pixels (54, 66, 74, 68, 76) each comprise a substantially equal amount of pixels.

19. A method (50, 62, 70) according to claim 16, wherein said first and mutually different sets of pixels (54, 66, 74, 68, 76) each comprise an amount of pixels less than half of the total amount of pixels in said matrix of pixels (52, 64, 72).

20. A method (50, 62, 70) according to claim 14, wherein said first set of pixels (54, 66, 74, 68, 76) comprises one or more entire rows (54, 66, 74) of pixels in said matrix of pixels (52, 64, 72).

21. A method (50, 62, 70) according to claim 14, wherein said compensating comprises adjusting a bias of a driver of said first set of pixels.

22. A method (50, 62, 70) according to claim 14, wherein said compensating comprises adjusting a video content of said first set of pixels (54, 66, 74) during said second frame (n).

23. Driving circuitry for a display device comprising a matrix of pixels, the driving circuitry comprising means for driving the pixels during a first frame (n−1) with a first polarity pattern, for driving the pixels with exception of a first set of pixels (54, 66, 74) during a second frame (n) with an inverted polarity pattern, and for driving the first set of pixels (54, 66, 74) with the inverted polarity pattern during a third frame (n+1); and means for compensating for a biasing difference (80) of said first set of pixels during said second frame (n) caused by a response time of the first set of pixels.

24. A display device comprising a display panel with a matrix of pixels; and the driving circuitry as claimed in claim 23.

25. A display product comprising the display device of claim 24, and video processing circuitry.
